(19) United States
(12) Patent Application Publication
(10) Pub. No.: US 2022/0370948 A1
(43) Pub. Date: Nov. 24, 2022

(54) SCRUBBER DEVICE

(71) Applicant: FUJI ELECTRIC CO., LTD., Kanagawa (JP)

(72) Inventor: Taichiro KATO, Musashino-city (JP)

(73) Assignees: FUJI ELECTRIC CO., LTD., Kanagawa (JP); FUJI ELECTRIC CO., LTD., Kanagawa (JP)

(21) Appl. No.: 17/737,953

(22) Filed: May 5, 2022

(30) Foreign Application Priority Data
May 18, 2021 (JP) 2021-083935

(51) Int. Cl. B01D 47/06; B01D 53/78; B01D 45/12; B01D 50/40

(52) U.S. Cl. CPC B01D 47/06; B01D 53/78; B01D 45/12; B01D 50/40; B01D 2257/55; B01D 2258/0283

(57) ABSTRACT

There is provided a scrubber device including: a reaction tower in which an internal space is formed; a liquid spray unit configured to spray a liquid in the internal space; a gas inlet port configured to introduce a gas to the reaction tower; a liquid outlet port configured to discharge, from the reaction tower, drainage generated by treatment of taking, into the liquid, a substance in the gas; a gas supply unit configured to supply the treated gas from the reaction tower; and a heating unit which is provided in at least a part of a portion close to the liquid outlet port with respect to the gas inlet port in the reaction tower, and a portion of a liquid outlet tube that is connected downstream from the liquid outlet port, and which is configured to heat the drainage.

The contents of the following Japanese patent application are incorporated herein by reference:

No. 2021-083935 filed in JP on May 18, 2021.

### BACKGROUND

### 1. Technical Field

The present invention relates to a scrubber device.

### 2. Related Art

In the related art, a scrubber device that removes suspended solids in geothermal water by using a cyclone separation technology has been known (for example, Patent Document 1 and Patent Document 2). In addition, a scrubber device in which a dry scrubber and a wet scrubber are connected has been known (for example, Patent Document 3). In addition, a technology that removes a precipitate of an inorganic salt compound such as calcium, magnesium, or silica contained in water, in a scrubber device for a ship, has been known (for example, Patent Document 4).

Patent Document 1 Japanese Patent Application Publication No. 11-239702

Patent Document 2 Japanese Unexamined Utility Model Application Publication No. 3-83615

Patent Document 3 International Publication No. WO2005/039723

Patent Document 4 International Publication No. WO2014/118819

### BRIEF DESCRIPTION OF THE DRAWINGS

FIG. 1 is a diagram showing an example of a geothermal power generation system to which a scrubber device according to an embodiment of the present invention is applied.

FIG. 2 is a diagram showing an example of a wet cyclone scrubber unit in the scrubber device of a first embodiment.

FIG. 3 is a diagram showing another example of the wet cyclone scrubber unit in the first embodiment.

FIG. 4 is a diagram showing an example of the wet cyclone scrubber unit in a second embodiment.

FIG. 5 is a diagram showing another example of the wet cyclone scrubber unit in the second embodiment.

FIG. 6 is a diagram showing another example of the wet cyclone scrubber unit in the second embodiment.

FIG. 7 is a diagram showing an example of the wet cyclone scrubber unit in a third embodiment.

FIG. 8 is a diagram showing another example of the wet cyclone scrubber unit in the third embodiment.

FIG. 9 is a diagram showing an example of a dry cyclone scrubber unit.

FIG. 10 is a diagram showing another example of the scrubber device.

FIG. 11 is a diagram showing an example of a ship system to which a scrubber device for a ship according to an embodiment of the present invention is applied.

### DESCRIPTION OF EXEMPLARY EMBODIMENTS

Hereinafter, the present invention will be described through embodiments of the invention, but the following embodiments do not limit the invention according to claims. Further, not all the combinations of features described in the embodiments are essential for means to solve the problem in the invention.

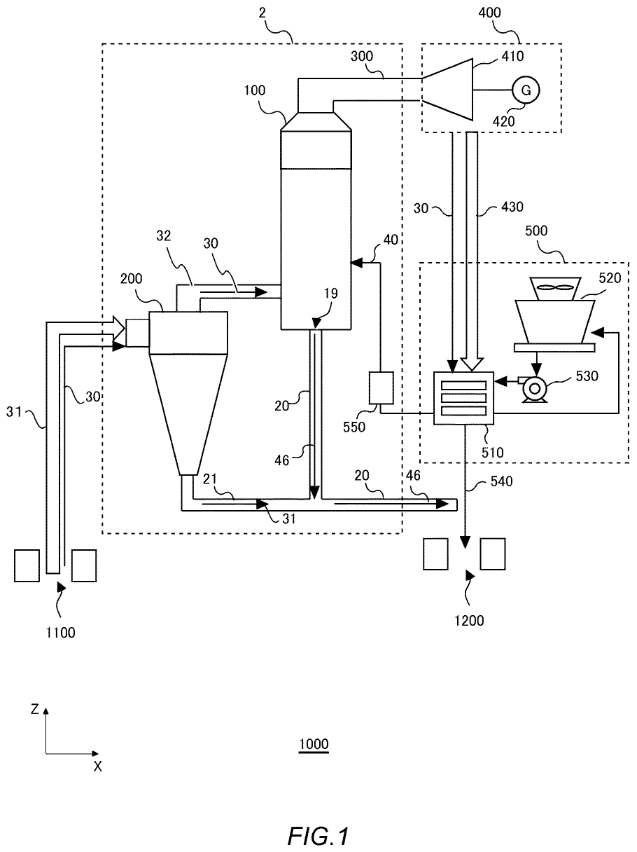

FIG. 1 is a diagram showing an example of a geothermal power generation system 1000 according to an embodiment of the present invention. The geothermal power generation system 1000 includes a scrubber device 2, a gas supply unit 300, a power generation device 400, and a gas recovery unit 500. In FIG. 1, the scrubber device 2 is a scrubber device for geothermal power generation. The scrubber device 2 treats a gas. In the present example, the gas is a vapor 30. Treating the gas refers to removing a harmful substance contained in the gas. In the present example, the scrubber device 2 treats the vapor 30 used for the geothermal power generation and supplies the treated vapor 30 to the power generation device 400 through the gas supply unit 300. The gas supply unit 300 may be a tube for supplying the treated vapor 30 to the power generation device 400. The vapor 30 may contain a mist. The scrubber device 2 supplies, to the power generation device 400, the vapor 30 that is cleaned by taking an impurity in the vapor 30 into a liquid 40. Drainage 46 generated by the treatment of taking a substance in the gas into the liquid 40 is discharged from a liquid outlet port 19 in a reaction tower of a wet cyclone scrubber unit 100, to an outside of the reaction tower through a liquid outlet tube 20. The scrubber device 2 prevents the impurity from precipitating in the drainage 46 and clogging a flow path of the drainage 46. Means for preventing the precipitation of the impurity will be described below.

The power generation device 400 includes a turbine 410 and a generator 420. In the present example, the generator 420 generates power by a rotation of the turbine 410 by the vapor 30. The gas recovery unit 500 recovers the vapor 30. The gas recovery unit 500 may be provided on a downstream side from the turbine 410 in a traveling direction of the vapor 30. In the present example, the gas recovery unit 500 has a recovery tank 510, a cooling tower 520, and a pump 530. The vapor 30 used in the power generation device 400 returns to a liquid 540 in the recovery tank 510. The recovery tank 510 functions as a condenser. The liquid 540 is further cooled in the cooling tower 520. The cooled liquid 540 is returned to the recovery tank 510 by the pump 530. The liquid 540 returned to the recovery tank 510 is used for cooling the vapor 30. The gas recovery unit 500 may recover condensed water 430 from a vicinity of the turbine 410. The liquid 540 of the recovery tank 510 may be introduced into a reduction well 1200. The reduction well 1200 is a well that returns the used liquid 540 to an underground geothermal reservoir.

The vapor 30 is acquired from a production well 1100. The vapor 30 may be pumped together with hot water 31. The production well 1100 is a well that pumps the vapor 30 and the hot water 31 from the underground geothermal reservoir. The vapor 30 from the production well 1100 may contain, as the impurity, fine dust such as earth and sand, silica, and sulfide. The scrubber device 2 removes the impurity in the vapor 30. This makes it possible to prevent a failure of the power generation device.

The scrubber device 2 has a wet cyclone scrubber unit 100. The scrubber device 2 may further have a dry cyclone scrubber unit 200. In the present example, the vapor 30 and the hot water 31 acquired in the production well 1100 are introduced into the dry cyclone scrubber unit 200. In the present example, the dry cyclone scrubber unit 200 executes a vapor-liquid separation between the vapor 30 and the hot water 31. In addition, the dry cyclone scrubber unit 200 removes comparatively large suspended solids in the fine dust in the vapor 30. The suspended solids include the silica in an example. Note that unlike the present example, the scrubber device 2 may not include the dry cyclone scrubber unit 200. In that case, a vapor-liquid separator may be provided instead of the dry cyclone scrubber unit 200.

The wet cyclone scrubber unit 100 treats the vapor 30 by the liquid 40. In the present example, the wet cyclone scrubber unit 100 treats the vapor 30 as the gas supplied from the dry cyclone scrubber unit 200. The liquid 40 is introduced into the wet cyclone scrubber unit 100. The liquid 40 may be water in an example, or may be water containing a solvent. As the liquid 40, the liquid 540, which is obtained by condensing the vapor 30 in the recovery tank 510 of the gas recovery unit 500, may be used. Note that the liquid 40 is not limited to this case, and may be water separately procured from the outside.

A pressure of the liquid 40 may be increased by a booster pump 550 to be higher than an internal pressure of the reaction tower of the wet cyclone scrubber unit 100. The liquid 40 of which the pressure has been increased is sprayed in the wet cyclone scrubber unit 100. The impurity contained in the vapor 30 is taken into the liquid 40. Taking the impurity may mean at least one of chemical dissolution, a chemical reaction, and physical absorption. By taking the impurity into the liquid 40, the impurity is removed from the vapor 30. The vapor 30 treated in this way is supplied from the wet cyclone scrubber unit 100, and is sent to the turbine 410 of the power generation device.

The drainage 46 generated by the treatment of taking the substance in the gas into the liquid 40 is discharged from the liquid outlet port 19 in the reaction tower of the wet cyclone scrubber unit 100, to the outside of the reaction tower through the liquid outlet tube 20. The drainage 46 means a liquid after a use in the treatment of taking the substance in the gas. In an example, the drainage 46 contains, as the impurity, the fine dust such as earth and sand, silica, and sulfide. In the present example, the hot water 31 obtained by the vapor-liquid separation by the dry cyclone scrubber unit 200 may also be discharged as the drainage 46 via a vapor-liquid separation tube 21. The drainage 46 may be introduced into the reduction well 1200. The scrubber device 2 of the present embodiment prevents the impurity such as the silica from precipitating and clogging the flow path, in the liquid outlet port 19 or the liquid outlet tube 20 in the reaction tower of the wet cyclone scrubber unit 100. A precipitate such as the silica is referred to as “scale”. A structure of the wet cyclone scrubber unit 100 for removing the scale will be described below.

With the scrubber device 2 shown in FIG. 1, the vapor 30 may travel from the dry cyclone scrubber unit 200 to the wet cyclone scrubber unit 100 in order. That is, the vapor 30 is treated in order of the dry cyclone scrubber unit 200 and the wet cyclone scrubber unit 100. The comparatively large suspended solids are removed in the dry cyclone scrubber unit 200, and then minute suspended solids are removed in the wet cyclone scrubber unit 100. This makes it possible to suppress a decrease and a loss of pressure of the vapor 30 by a simple structure. In addition, it is possible to prevent the minute suspended solids from passing through.

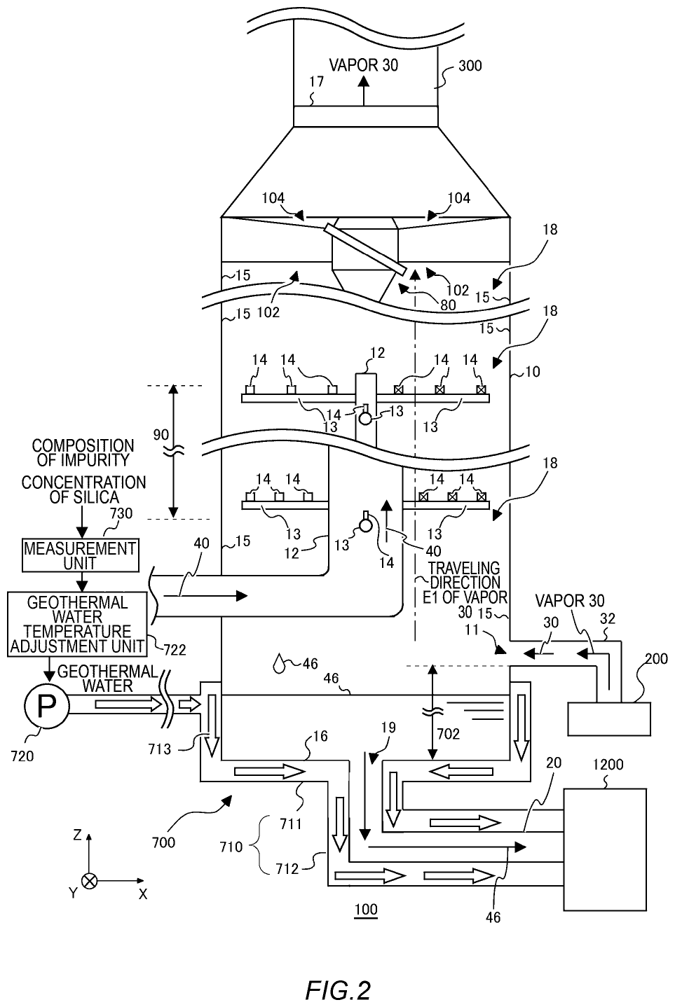

FIG. 2 is a diagram showing an example of a wet cyclone scrubber unit 100 in the scrubber device 2. The wet cyclone scrubber unit 100 includes a reaction tower 10. In the reaction tower 10, a gas treatment unit 18 that is an internal space is formed. The scrubber device 2 may include a gas inlet tube 32 and the liquid outlet tube 20. In the present example, the vapor 30 is introduced into the reaction tower 10 from the dry cyclone scrubber unit 200.

The reaction tower 10 has a gas inlet port 11 configured to introduce a gas to be treated. The gas inlet port 11 is configured to introduce, into the reaction tower 10, the vapor 30 that is used for the geothermal power generation, as a gas. The reaction tower 10 has a gas outlet port 17 for discharging the treated gas from the reaction tower 10. The gas supply unit 300, which is configured to supply the treated gas from the reaction tower 10, is connected to the gas outlet port 17. In the present example, the gas supply unit 300 is configured to supply the treated vapor 30 to the power generation device 400. The reaction tower 10 is supplied with the liquid 40 for treating the vapor 30. The liquid 40 supplied to the reaction tower 10 treats the vapor 30 inside the reaction tower 10. The liquid 40 becomes the drainage 46 after treating the vapor 30.

The reaction tower 10 of the present example has a side wall 15, a bottom surface 16, the gas treatment unit 18, and the liquid outlet port 19. The reaction tower 10 of the present example is cylindrical. In the present example, the gas outlet port 17 is arranged at a location opposite to the bottom surface 16 in a direction parallel to a central axis of the cylindrical reaction tower 10. In the present example, the side wall 15 and the bottom surface 16 are respectively an internal side surface and the bottom surface 16 of the cylindrical reaction tower 10. The gas inlet port 11 may be provided on the side wall 15. In the present example, the vapor 30 passes through the gas inlet port 11 from the gas inlet tube 32, and then is introduced into the gas treatment unit 18.

The gas treatment unit 18 is the internal space surrounded by the side wall 15, the bottom surface 16, and the gas outlet port 17. The gas treatment unit 18 is in contact with the side wall 15, the bottom surface 16, and the gas outlet port 17. The gas treatment unit 18 treats the vapor 30 inside the reaction tower 10. The bottom surface 16 is a surface on which the drainage drops. The drainage 46 passes through the liquid outlet port 19, and then is discharged through the liquid outlet tube 20. The liquid outlet port 19 is configured to discharge, from the reaction tower 10, the drainage generated by the treatment of taking, into the liquid, the substance in the gas, that is, the vapor 30.

The side wall 15 and the bottom surface 16 are formed of a material that is durable against the vapor 30, the liquid 40, and the drainage 46. The material may be a combination of an iron material such as SS400 and S-TEN (registered trademark) and at least one of a coating agent and an application agent, a copper alloy such as naval brass, an aluminum alloy such as aluminum brass, a nickel alloy such as cupronickel, Hastelloy (registered trademark), or stainless steel such as SUS316L, SUS329J4L, or SUS312.

In the present specification, technical matters may be described by using orthogonal coordinate axes of an X axis, a Y axis, and a Z axis. In the present specification, a plane parallel to the bottom surface 16 of the reaction tower 10 is set as an XY plane, and a direction from the bottom surface 16 toward the gas outlet port 17 (a direction perpendicular to the bottom surface 16) is set as the Z axis. In the present specification, a predetermined direction in the XY plane is set as an X axis direction, and a direction orthogonal to the X axis in the XY plane is set as a Y axis direction.

A Z axis direction may be parallel to a direction of gravity. When the Z axis direction is parallel to the direction of gravity, the XY plane may be a horizontal plane. The Z axis direction may be parallel to a horizontal direction. When the Z axis direction is parallel to the horizontal direction, the XY plane may be parallel to the direction of gravity.

In the present specification, a side view refers to a case where the gas treatment device is viewed from a direction perpendicular to the Z axis (a predetermined direction in the XY plane). In the present specification, a side view diagram refers to a diagram of the side view.

In the wet cyclone scrubber unit 100, the vapor 30 introduced into the reaction tower 10 swirls inside the reaction tower 10, and travels in a direction from the gas inlet port 11 to the gas outlet port 17 (in the present example, the Z axis direction). In the present example, the vapor 30 swirls in the XY plane when viewed in a direction from the gas outlet port 17 to the bottom surface 16.

The reaction tower 10 has a liquid spray unit 90. The liquid spray unit 90 is provided between the gas inlet port 11 and the gas outlet port 17. A region of the liquid spray unit 90 may be a part of a region between the gas inlet port 11 and the gas outlet port 17 in the traveling direction (the Z axis direction) of the vapor 30. The region of the liquid spray unit 90 may be an entire region of the reaction tower 10 when the reaction tower 10 is viewed in the direction from the gas outlet port 17 to the bottom surface 16 (the XY plane). The liquid spray unit 90 is configured to spray the liquid 40 in the internal space of the reaction tower 10.

The reaction tower 10 may have one or more trunk tubes 12 through which the liquid 40 is supplied, and one or more branch tubes 13. The reaction tower 10 may have one or more spray nozzle units 14 for spraying the liquid 40. In the present example, the spray nozzle unit 14 is connected to the branch tube 13, and the branch tube 13 is connected to the trunk tube 12.

In the present example, at least a part of the trunk tube 12, the branch tube 13, and the spray nozzle unit 14 are provided in the liquid spray unit 90. In the drawing, a range of the liquid spray unit 90 inside the reaction tower 10 is indicated by a double-headed arrow. The liquid spray unit 90 may spray the liquid 40 in a range, in a direction parallel to the Z axis, from the spray nozzle unit 14 arranged closest to a gas inlet port 11 side, to the spray nozzle unit 14 arranged closest to a gas outlet port 17 side. The liquid spray unit 90 may spray the liquid 40 in a range surrounded by the side wall 15 in the XY plane.

In the present example, the vapor 30 swirls in the liquid spray unit 90 in a predetermined direction (a swirling direction), and travels inside the reaction tower 10 in a direction from the gas inlet port 11 to the gas outlet port 17. The traveling direction of the vapor 30 from the gas inlet port 11 to the gas outlet port 17 inside the reaction tower 10 is set as a traveling direction E1. In the present example, the traveling direction E1 of the vapor 30 is parallel to the Z axis. That is, in the present example, the vapor 30 travels in the traveling direction E1 in the side view of the reaction tower 10, and swirls in a swirling direction F when viewed from the traveling direction E1.

In the present example, the wet cyclone scrubber unit 100 includes a swirl unit 80. The swirl unit 80 has an inlet end 102 into which the vapor 30 is introduced and a supply end 104 from which the vapor 30 is supplied. The vapor 30 travels inside the swirl unit 80 in a direction from the inlet end 102 to the supply end 104. The traveling direction of the vapor 30 from the inlet end 102 to the supply end 104 is parallel to the Z axis. That is, in the present example, the vapor 30 travels in the traveling direction E1 in the side view of the swirl unit 80, and swirls in a predetermined swirling direction when viewed from the traveling direction E1.

In the present example, the cylindrical reaction tower 10 may be mounted such that the central axis of the reaction tower 10 is parallel to a vertical direction, or may be mounted such that the central axis is parallel to the horizontal direction. When the reaction tower 10 is mounted such that the central axis is parallel to the vertical direction, the traveling direction E1 (the direction parallel to the Z axis) of the vapor 30 is a direction which is parallel to the vertical direction and is from a bottom to a top in the vertical direction. When the reaction tower 10 is mounted such that the central axis is parallel to the horizontal direction, the traveling direction E1 (the direction parallel to the Z axis) of the vapor 30 is parallel to the horizontal direction.

The swirl unit 80 of the present example is provided on the downstream side of the vapor 30 from the liquid spray unit 90 in the traveling direction of the vapor 30 (the Z axis direction in the present example). In the present example, the swirl unit 80 is provided between the liquid spray unit 90 and the gas outlet port 17 in the Z axis direction. The swirl unit 80 increases a speed of the vapor 30.

In the present example, the gas inlet port 11 is provided on a side surface at a location, in the Z axis direction, closer to the bottom surface 16 than the gas outlet port 17 in the side view. In the reaction tower 10, a portion close to the liquid outlet port 19 with respect to the gas inlet port 11 is referred to as a liquid outlet region 702.

The wet cyclone scrubber unit 100 of the present example includes a heating unit 700. The heating unit 700 is provided in at least a part of the liquid outlet region 702, and a portion of the liquid outlet tube 20 that is connected downstream from the liquid outlet port 19, and is configured to heat the drainage 46. The heating unit 700 may include a first heating unit that heats the liquid outlet region 702 of the reaction tower 10, and a second heating unit that heats the portion of the liquid outlet tube 20. In the present example, the heating unit 700 may heat, by geothermal water 713, at least a part of the liquid outlet region 702 and the liquid outlet tube 20 of the wet cyclone scrubber unit 100. The geothermal water 713 may be the hot water 31 pumped from the production well 1100, or may be a liquid obtained by diluting the hot water 31 and adjusting a temperature according to needs.

The heating unit 700 includes a heating tube 710 and a pump 720. The heating tube 710 may include a first heating tube 711 and a second heating tube 712. The first heating tube 711 is provided to cover the side wall 15 and the bottom surface 16 of the reaction tower 10 from the outside of the reaction tower 10 in the liquid outlet region 702 of the reaction tower 10. On the other hand, the second heating tube 712 is provided to cover a side surface of the liquid outlet tube 20 from the outside of the liquid outlet tube 20. The first heating tube 711 and the second heating tube 712 may communicate with each other. It should be noted that the heating unit 700 may have at least one of the first heating tube 711 and the second heating tube 712. The pump 720 circulates the geothermal water 713 in the heating tube 710. The heating unit 700 may heat the drainage 46 to 70° C. or higher, may heat the drainage 46 to 80° C. or higher, or may heat the drainage 46 to 100° C. or higher.

In this way, the heating unit 700 heats at least a part of the liquid outlet region 702 of the reaction tower 10 and the liquid outlet tube 20, thereby preventing the minute suspended solids in the drainage 46, that is, silica, calcium, aluminum, magnesium, and the like from precipitating. As a result, it is possible to prevent generation of the “scale” and to prevent the scale from clogging the flow path of the drainage 46. In particular, when the drainage 46 is a silica solution, it is possible to reduce generation of silica scale due to the precipitation of the silica.

The heating unit 700 may include a measurement unit 730 and a geothermal water temperature adjustment unit 722. In an example, the measurement unit 730 may measure a concentration or composition of the impurity (the suspended solids) in the vapor 30, or may measure a concentration or composition of the impurity (the suspended solids) in the drainage 46. In an example, the measurement unit 730 may measure a concentration of the silica in the vapor 30, and may measure a concentration of the silica in the drainage 46. It should be noted that the related art can be used for the measurement of the concentration or the composition in the measurement unit 730, the detailed description thereof will be omitted.

The geothermal water temperature adjustment unit 722 may change a temperature at which the drainage 46 is heated according to a measurement result by the measurement unit 730. The geothermal water temperature adjustment unit 722 may adjust the temperature of the geothermal water 713 by a selection in the geothermal water 713 collected at different collection locations according to the measurement result by the measurement unit 730. The heating unit 700 may change a heating temperature of the drainage 46 based on the composition of the impurity in the gas (steam 30) or in the drainage. In addition, the heating unit 700 may change the heating temperature of the drainage 46 based on the concentration of the silica in the gas (the steam 30) or in the drainage 46. In an example, the higher the concentration of the silica is, the easier the precipitation of the silica is, and thus the heating temperature may be increased to suppress the precipitation of the silica. Alternatively, when a precipitation temperature at which the precipitation of the suspended solids is started is determined according to the composition, the heating temperature may be increased such that a temperature of the drainage 46 is the precipitation temperature or higher. Note that the heating unit 700 may have a configuration in which the measurement unit 730 and the geothermal water temperature adjustment unit 722 are not included.

With the wet cyclone scrubber unit 100 shown in FIG. 2, it is possible to take, into the liquid 40, the impurity in the gas, that is, the vapor 30 in the present example, to be cleaned, and then supply the vapor 30 to the turbine 410 of the power generation device. Further, the heating unit 700 heats the drainage 46 by heating at least a part of the liquid outlet region 702 and the liquid outlet tube 20 of the wet cyclone scrubber unit 100. Accordingly, it is possible to suppress a decrease of the temperature of the drainage 46, and the precipitation of the silica.

In addition, it is possible to increase the heating temperature according to the concentration of the silica in the vapor 30 or the concentration of the silica in the drainage, and thus it is possible to effectively use the geothermal water 713. Note that the heating unit 700 is not limited to heating the drainage by using the geothermal water.

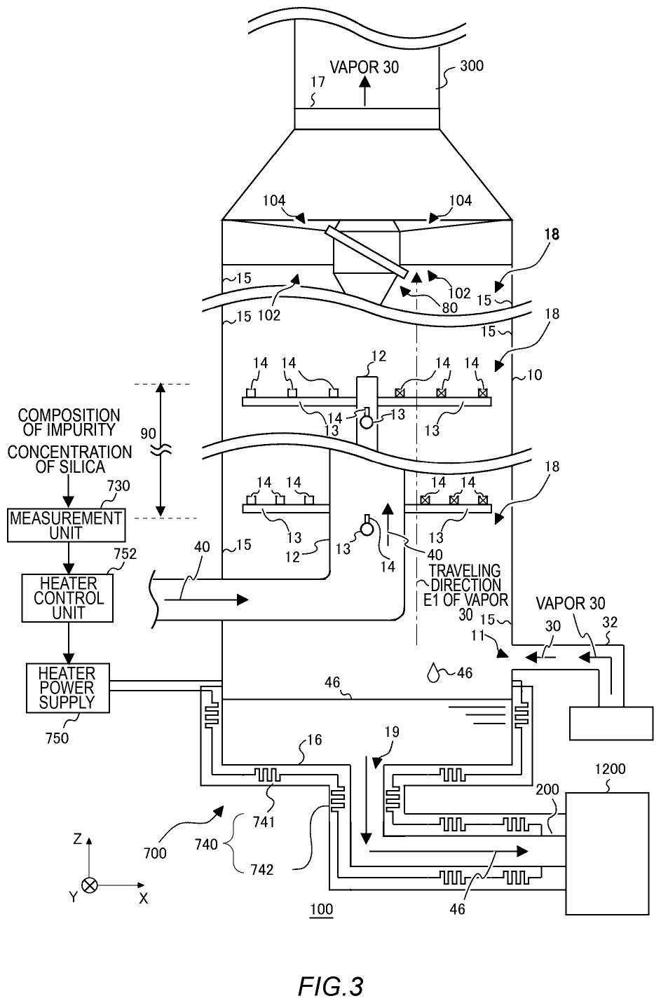

FIG. 3 is a diagram showing another example of the wet cyclone scrubber unit 100 in the scrubber device 2. The structure of the wet cyclone scrubber unit 100 shown in the drawing is similar to the structures of the wet cyclone scrubber unit 100 of the scrubber device 2 shown in FIG. 1 and FIG. 2 other than a configuration of the heating unit 700. Accordingly, the repeated description will be omitted.

The heating unit 700 shown in FIG. 3 is also provided in at least a part of the liquid outlet region 702, and a portion of the liquid outlet tube 20 that is connected downstream from the liquid outlet port 19, and is configured to heat the drainage 46. The heating unit 700 of the present example is provided in both of the liquid outlet region 702, and the liquid outlet tube 20 that is connected downstream from the liquid outlet port 19. The heating unit 700 may include a first heating unit that heats the liquid outlet region 702 of the reaction tower 10, and a second heating unit that heats the portion of the liquid outlet tube 20. In the present example, the heating unit 700 includes a heater unit 740 and a heater power supply 750. The heater unit 740 heats at least a part of the liquid outlet region 702 and the liquid outlet tube 20 of the wet cyclone scrubber unit 100. The heater unit 740 may be an electrical heater or may be an infrared heater. In the present example, the heater unit 740 is an electrical heater.

The heater unit 740 may include a plurality of heaters. In an example, the heater unit 740 may include a first heater unit 741 and a second heater unit 742. The first heater unit 741 may be provided to cover the side wall 15 and the bottom surface 16 of the reaction tower 10 from the outside of the reaction tower 10 in the liquid outlet region 702 of the reaction tower 10. On the other hand, the second heater unit 742 is provided to cover the side surface of the liquid outlet tube 20 from the outside of the liquid outlet tube 20. The first heater unit 741 and the second heater unit 742 may be connected in series or in parallel. It should be noted that the heating unit 700 may have at least one of the first heater unit 741 and the second heater unit 742. The heater power supply 750 supplies the power to the heater unit 740. The first heater unit 741 and the second heater unit 742 are electrical resistors in an example, and Joule heat is generated by a current flowing through them. In the present example as well, the heating unit 700 may heat the drainage 46 to 70° C. or higher, may heat the drainage 46 to 80° C. or higher, or may heat the drainage 46 to 100° C. or higher.

In this way, the heating unit 700 heats at least a part of the liquid outlet region 702 of the reaction tower 10 and the liquid outlet tube 20, thereby preventing the minute suspended solids in the drainage 46, that is, silica, calcium, aluminum, magnesium, and the like from precipitating, and thus it is possible to prevent the generation of the “scale” and to prevent the scale from clogging the flow path of the drainage 46. In particular, when the drainage is the silica solution, it is possible to prevent the silica from precipitating.

The heating unit 700 may include the measurement unit 730 and a heater control unit 752. The measurement unit 730 is similar to the case shown in FIG. 2, and the heater control unit 752 may change the temperature at which the drainage 46 is heated according to a measurement result by the measurement unit 730. The heater control unit 752 may adjust the heating temperature by adjusting the power supplied from the heater power supply 750 to the heater unit 740 according to the measurement result by the measurement unit 730. As a result, the heating unit 700 may change the heating temperature of the drainage 46 based on the composition of the impurity in the gas (the steam 30) or in the drainage. In addition, the heating unit 700 may change the heating temperature of the drainage 46 based on the concentration of the silica in the gas (the steam 30) or in the drainage. With the configuration shown in FIG. 3 as well, it is possible to suppress the decrease of the temperature of the drainage, and the precipitation of the silica.

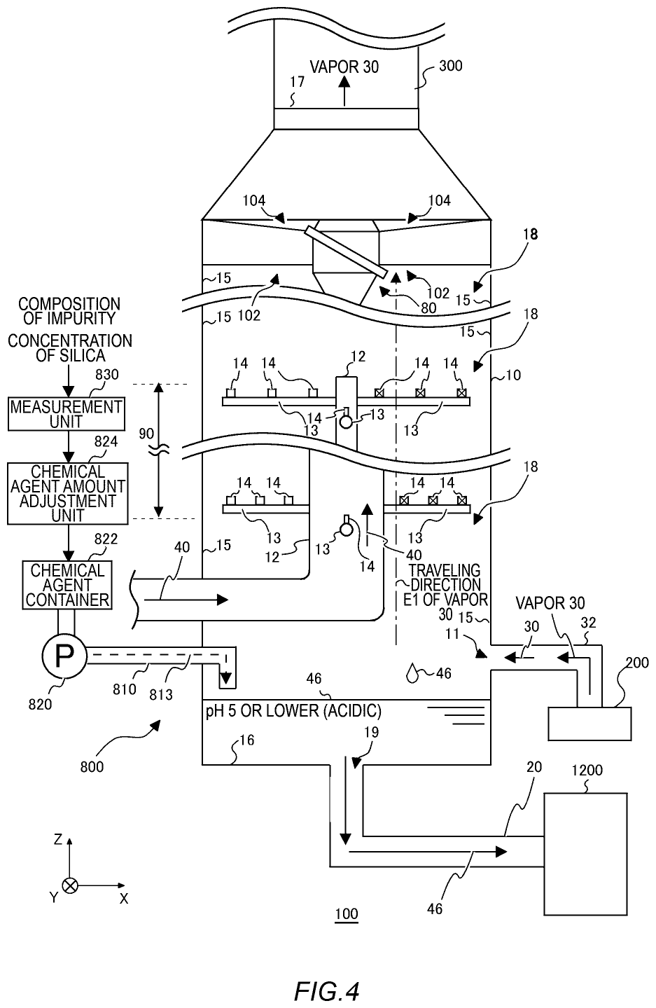

FIG. 4 is a diagram showing an example of the wet cyclone scrubber unit 100 in the scrubber device 2 of a second embodiment. The wet cyclone scrubber unit 100 in the scrubber device 2 of the present embodiment includes a chemical agent inlet unit 800 configured to cause a chemical agent 813 to be contained in the drainage 46. In addition, in FIG. 4, the heating unit 700 is omitted. Other than these points, the structure of the wet cyclone scrubber unit 100 is similar to the structures of the wet cyclone scrubber unit 100 shown in FIG. 1 to FIG. 3. Accordingly, the repeated description will be omitted. It should be noted that the wet cyclone scrubber unit 100 may include both the chemical agent inlet unit 800 and the heating unit 700.

The chemical agent inlet unit 800 causes the chemical agent 813 to be contained in the drainage 46. The chemical agent 813 may be a chemical agent that adjusts the drainage 46 to be acidic. In particular, the chemical agent 813 may adjust a hydrogen ion exponent (pH) of the drainage 46 to 5.5 or lower. The chemical agent 813 may contain various acids such as HCl used to adjust the hydrogen ion exponent. In the example shown in FIG. 4, the chemical agent inlet unit 800 includes a chemical agent inlet tube 810, a pump 820, a chemical agent container 822, a chemical agent amount adjustment unit 824, and a measurement unit 830.

In the present example, an internal surface of the reaction tower 10 may be formed of a material resistant to the chemical agent 813. The chemical agent inlet tube 810 may penetrate a side surface of the reaction tower 10. The chemical agent inlet tube 810 introduces the chemical agent 813 into the reaction tower 10. The chemical agent 813 introduced into the reaction tower 10 via the chemical agent inlet tube 810 is caused to be contained in the drainage 46 that is stored on the bottom surface 16 in the reaction tower 10. As a result, the hydrogen ion exponent of the drainage 46 is adjusted. The adjusted drainage is introduced into the reduction well 1200 through the liquid outlet port 19 and the liquid outlet tube 20. It should be noted that the drainage 46 may be neutralized by a neutralizing agent before being introduced into the reduction well 1200.

In this way, by adjusting the hydrogen ion exponent of the drainage 46, it is possible to suppress the formation of the “scale” due to the precipitation of the minute suspended solids in the drainage 46, that is, silica, calcium, aluminum, magnesium, and the like. As a result, it is possible to prevent the scale from clogging the flow path of drainage. In particular, when the drainage is the silica solution, it is possible to reduce the precipitation of the silica.

The measurement unit 830 is similar to the measurement unit 730 of FIG. 2. Accordingly, the repeated description will be omitted. The chemical agent amount adjustment unit 824 adjusts the hydrogen ion exponent (pH) of the drainage 46 according to a measurement result of the measurement unit 830. Specifically, the chemical agent amount adjustment unit 824 adjusts a concentration or an amount of the chemical agent 813 to be mixed with the drainage 46. In an example, the chemical agent 813 of which the amount or the concentration has been adjusted is temporarily stored in the chemical agent container 822. The pump 820 injects the chemical agent 813 in the chemical agent container 822 into the reaction tower 10 through the chemical agent inlet tube 810. As a result, the chemical agent inlet unit 800 may change the hydrogen ion exponent of the drainage 46 based on the composition of the impurity in the gas (the steam 30) or in the drainage. In addition, the chemical agent inlet unit 800 may change the hydrogen ion exponent of the drainage 46 based on the concentration of the silica in the gas (the steam 30) or in the drainage. Note that the chemical agent inlet unit 800 may not have the measurement unit 830 and the chemical agent amount adjustment unit 824.

With the wet cyclone scrubber unit 100 shown in FIG. 4, it is possible to take, into the liquid 40, the impurity in the gas, that is, the vapor 30 in the present example, to be cleaned, and then supply the vapor 30 to the turbine 410 of the power generation device 400. Further, for the drainage 46 generated by taking the impurity into the liquid 40, by causing the chemical agent 813 to be contained in the drainage 46 in the wet cyclone scrubber unit 100, the drainage 46 is adjusted to exhibit acidity. In an example, the hydrogen ion exponent of the drainage 46 is adjusted to be 5.5 or lower. As a result of the hydrogen ion exponent of the drainage 46 being 5.5 or lower, it is possible to suppress the precipitation of the silica. In addition, it is possible to adjust the hydrogen ion exponent to an appropriate value according to the concentration of the silica in the vapor 30 or the concentration of the silica in the drainage 46. This makes it possible to reduce corrosion of the tube, through which the drainage 46 flows, by the chemical agent 813 as much as possible.

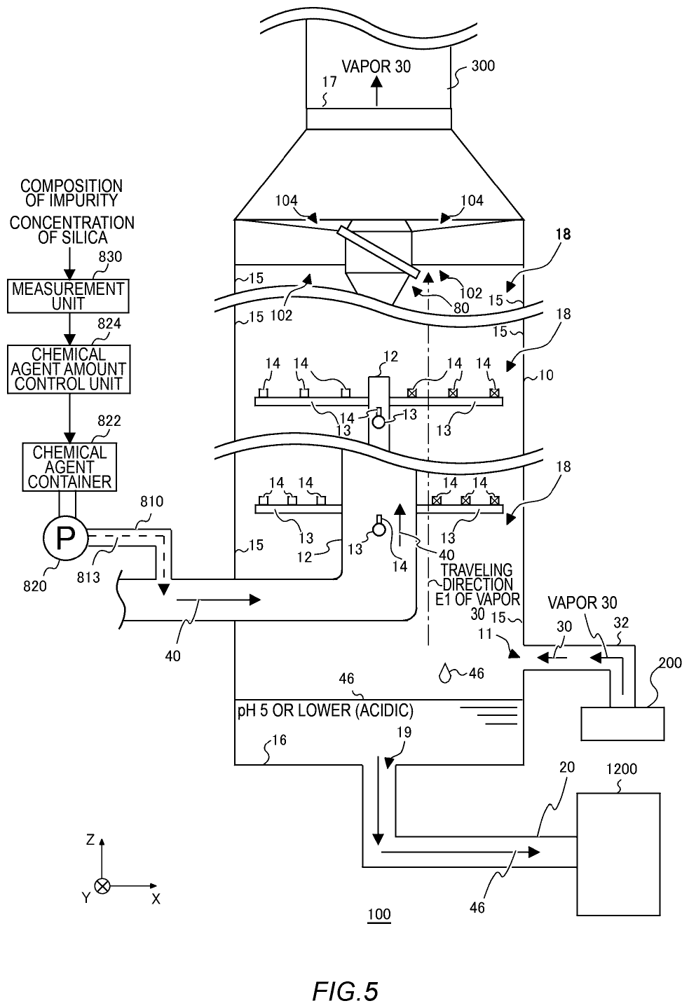

FIG. 5 is a diagram showing another example of the wet cyclone scrubber unit 100 in the scrubber device 2 of the second embodiment. In FIG. 5, the chemical agent inlet tube 810 is connected to the trunk tube 12 that introduces the liquid 40 into the reaction tower 10. As a result, the hydrogen ion exponent of the liquid 40 is adjusted upstream from where the liquid 40 is sprayed. As a result, the hydrogen ion exponent is adjusted also for the drainage 46 generated by taking the impurity into the liquid 40. Other configurations are similar to the configuration of the wet cyclone scrubber unit 100 in the scrubber device of the second embodiment shown in FIG. 4. Accordingly, the detailed description will be omitted.

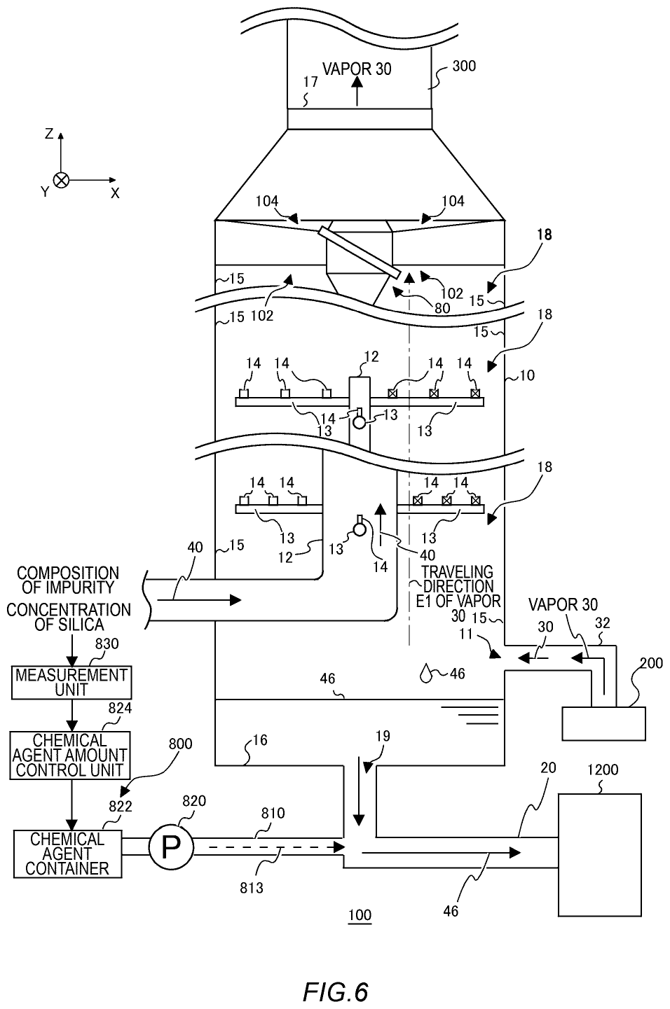

FIG. 6 is a diagram showing another example of the wet cyclone scrubber unit 100 in the scrubber device 2 of the second embodiment. In FIG. 6, the chemical agent inlet tube 810 is connected to the liquid outlet tube 20, which is connected downstream from the liquid outlet port 19. Thereby, for the drainage 46 downstream from a connection portion between the chemical agent inlet tube 810 and the liquid outlet tube 20, it is possible to adjust the hydrogen ion exponent of the drainage 46. It is desirable for the chemical agent inlet tube 810 to be connected to the liquid outlet tube 20 to be close to the liquid outlet port 19. In an example, it is desirable for the chemical agent inlet tube 810 to be connected to the liquid outlet tube 20 in a region within 1 m from the liquid outlet port 19.

With the configurations as shown in FIG. 5 and FIG. 6, it is also possible to adjust the hydrogen ion exponent of the drainage 46. This makes it possible to suppress the formation of the “scale” due to the precipitation of the minute suspended solids in the drainage 46, that is, silica, calcium, aluminum, magnesium, and the like. As a result, it is possible to prevent the scale from clogging the flow path of drainage. In particular, when the drainage is the silica solution, it is possible to reduce the precipitation of the silica. In addition, it is possible to remove the precipitated silica or the like.

It should be noted that it is possible to perform, in combination, the treatment by the heating unit 700 shown in FIG. 2 and FIG. 3, and the treatment by the chemical agent inlet unit 800 shown in FIG. 4 to FIG. 6. In this case, in an example, the heating unit 700 may continuously and constantly heat the drainage 46 during an operation of the geothermal power generation, and the chemical agent inlet unit 800 may perform the treatment to cause the chemical agent 813 to be temporarily contained in the drainage 46 when the composition of the impurity or the concentration of the silica in the gas (the vapor 30) or in the drainage 46 satisfies a predetermined condition. Thereby, it is possible to suppress the generation of the scale by the heat treatment so as to avoid, as much as possible, damage to the liquid outlet tube 20 through which the drainage 46 flows, and the internal surface of the reaction tower 10, and it is possible to execute the chemical treatment in a limited case of the composition of the impurity or the concentration of the silica in which the scale is generated even by the heat treatment.

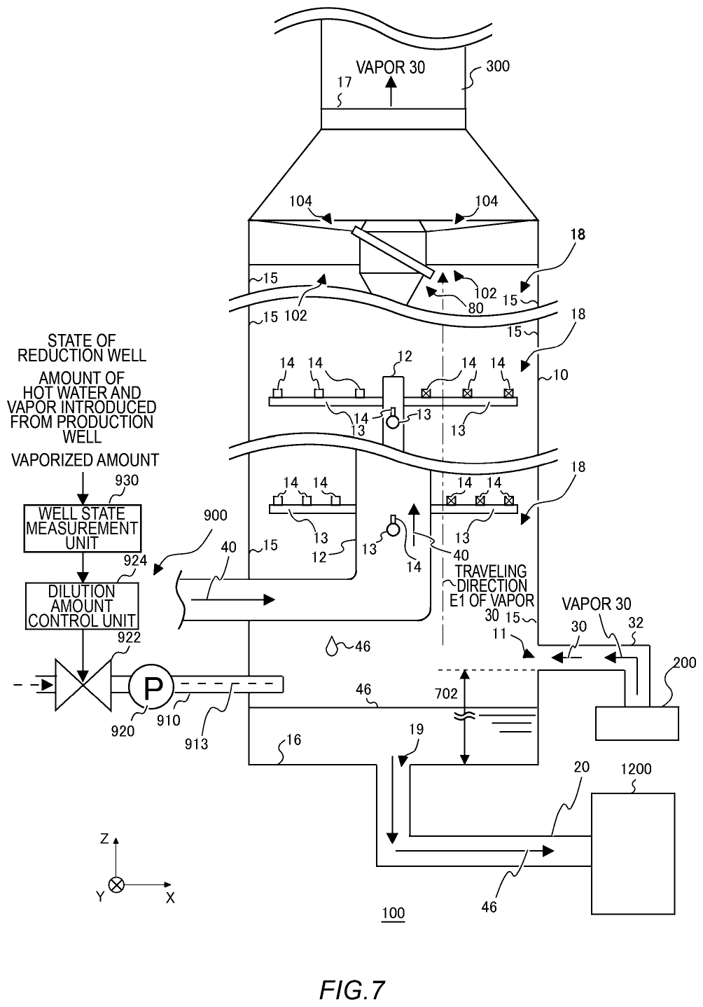

FIG. 7 is a diagram showing an example of the wet cyclone scrubber unit 100 in the scrubber device 2 of a third embodiment. The wet cyclone scrubber unit 100 in the scrubber device 2 of the present embodiment includes a dilution solution supply unit 900. In addition, in FIG. 7, the heating unit 700 and the chemical agent inlet unit 800 are omitted. Other than these points, the structure of the wet cyclone scrubber unit 100 is similar to the structures of the wet cyclone scrubber unit 100 shown in FIG. 1 to FIG. 6. Accordingly, the repeated description will be omitted. It should be noted that the wet cyclone scrubber unit 100 may include both the dilution solution supply unit 900 and the heating unit 700.

The dilution solution supply unit 900 shown in FIG. 7 is configured to supply a dilution solution 913 for diluting the drainage 46. The dilution solution supply unit 900 is provided in at least a part of the liquid outlet region 702 of the reaction tower 10, and a portion of the liquid outlet tube 20 that is connected downstream from the liquid outlet port 19. The dilution solution 913 may be, for example, water. The dilution solution supply unit 900 may collect river water or the like as the dilution solution 913. In the example shown in FIG. 7, the dilution solution supply unit 900 may include a dilution solution inlet tube 910, a pump 920, an adjustment valve 922, a dilution amount control unit 924, and a well state measurement unit 930.

The dilution solution inlet tube 910 may penetrate the side surface of the reaction tower 10. The dilution solution inlet tube 910 introduces the dilution solution 913 into the reaction tower 10. It is desirable for the dilution solution inlet tube 910 to be provided in the liquid outlet region 702 of the reaction tower 10. When the dilution solution 913 is introduced into the reaction tower 10 on the gas outlet port 17 side, heat of the vapor 30 may be taken away by the dilution solution 913. Accordingly, it is advantageous to provide the dilution solution inlet tube 910 in the liquid outlet region 702 of the reaction tower 10.

The dilution solution 913 introduced into the reaction tower 10 via the dilution solution inlet tube 910 dilutes the drainage 46 that is stored on the bottom surface 16 in the reaction tower 10. As a result, it is possible to lower the concentration of the impurity such as silica, calcium, aluminum, and magnesium in the drainage 46. Accordingly, it is possible to suppress the formation of the “scale” due to the precipitation of silica, calcium, aluminum, magnesium, and the like.

The well state measurement unit 930 may measure an amount of the liquid (an amount of water) in the reduction well 1200 for returning, to the underground geothermal reservoir, the vapor 30 used for the geothermal power generation, by returning the vapor 30 to the liquid. Instead of this or in addition to this, the well state measurement unit 930 may measure amounts of the vapor 30 and the hot water, which are pumped from the geothermal reservoir, in the production well 1100.

The dilution amount control unit 924 adjusts an amount of supply of the dilution solution 913 based on a measurement result of the well state measurement unit 930. Specifically, the dilution amount control unit 924 may adjust an opening degree of the adjustment valve 922. The adjustment valve 922 adjusts the amount of supply of the dilution solution 913 according to the opening degree. This makes it possible for the dilution solution supply unit 900 to adjust the amount of supply of the dilution solution based on the amount of water in the reduction well 1200. When the amount of water in the reduction well 1200 is small, the dilution solution supply unit 900 may increase the amount of supply of the dilution solution 913. Such an adjustment makes it possible to perform an adjustment for the liquid in the reduction well 1200 not to overflow.

In addition, the dilution solution supply unit 900 may adjust the amount of supply of the dilution solution 913 based on amounts of the vapor 30 and the hot water 31, which are pumped from the geothermal reservoir, in the production well 1100. For example, the dilution amount control unit 924 calculates, from information of the production well 1100 and the reduction well 1200, an amount of the vapor 30 vaporized in the flow path between the production well 1100 and the reduction well 1200 and released to the outside. Further, the dilution amount control unit 924 may supply the dilution solution 913 in an amount corresponding to the amount of the vapor 30 vaporized and released to the outside. This makes it possible to return, to the reduction well 1200, the drainage 46 corresponding to the amounts of the vapor 30 and the hot water 31 pumped from the production well 1100. Note that the dilution solution supply unit 900 may not necessarily have the well state measurement unit 930 and the dilution amount control unit 924.

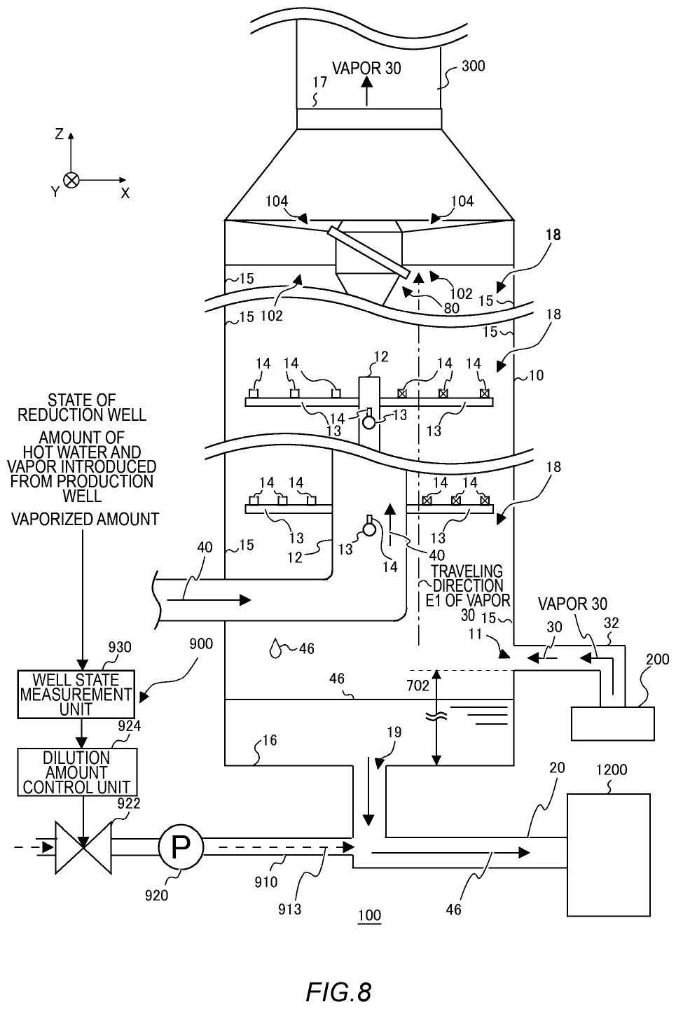

FIG. 8 is a diagram showing another example of the wet cyclone scrubber unit 100 in the scrubber device of a third embodiment. In FIG. 8, the dilution solution inlet tube 910 is connected to the liquid outlet tube 20, which is connected downstream from the liquid outlet port 19. Thereby, for the drainage 46 downstream from a connection portion between the dilution solution inlet tube 910 and the liquid outlet tube 20, it is possible to lower the concentration of the silica and the like in the drainage 46. It is desirable for the dilution solution inlet tube 910 to be connected to the liquid outlet tube 20 to be close to the liquid outlet port 19. For example, it is desirable for the dilution solution inlet tube 910 to be connected to the liquid outlet tube 20 in a region within 1 m from the liquid outlet port 19. This makes it possible to suppress the precipitation of silica, calcium, aluminum, magnesium, and the like, and formation of the “scale”.

The scrubber device 2 may include the wet cyclone scrubber unit 100 shown in FIG. 1 to FIG. 8, and further, the scrubber device 2 may include the dry cyclone scrubber unit 200.

As shown in FIG. 1 to FIG. 8, the dry cyclone scrubber unit 200 may be provided on an upstream side of the gas inlet port 11. Inside the dry cyclone scrubber unit 200, a swirling space, where a suspension swirls, is formed.

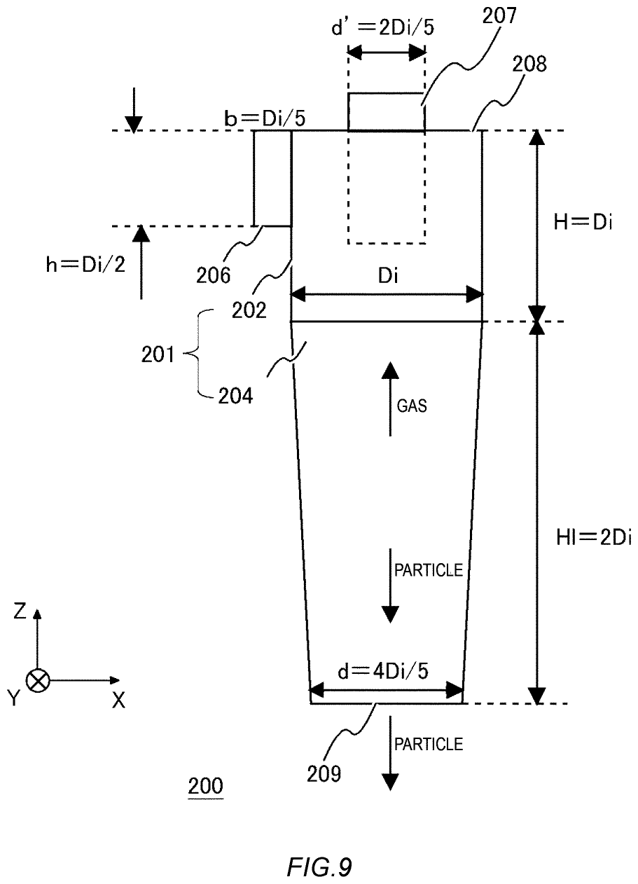

FIG. 9 shows an example of a dry cyclone scrubber unit 200. The dry cyclone scrubber unit 200 has a tube body 201. The tube body 201 has a cylindrical unit 202 and a conical unit 204 communicating with each other at ends. The conical unit 204 changes to be small in diameter from one end toward the other end in the Z axis direction. An inlet 206 is provided on a side surface of the cylindrical unit 202. One end of the cylindrical unit 202 and one end of the conical unit 204 communicate with each other. The other end of the conical unit 204 is a dust outlet port 209. At the other end of the cylindrical unit 202, a partition plate 208 that separates an internal space of the dry cyclone scrubber unit 200 from an outside is provided. At the center of the partition plate 208, a gas outflow port 207 that passes through the internal space of the dry cyclone scrubber unit 200 and the outside is provided.

It is assumed that a diameter of an outer cylinder of the cylindrical unit 202 is Di. A height H of the cylindrical unit 202 is Di, and a height Hl of the conical unit 204 is 2Di. A height of the inlet 206 in the Z axis direction is Di/2. A width b of the inlet 206 in the Y direction is Di/5. A diameter d′ of the gas outflow port 207 is 2Di/5. A diameter d of the dust outlet port 209 is 4Di/5. In this case, a viscosity of the gas is set as μ (kg/m·s), a density of dust is set as ρ (kg/m), a speed of the gas at the inlet 206 is set as u (m/s), and a density of a dust particle is set as ρₚ (kg/m). In this case, a limit minimum radius Dₚₘᵢₙ of a separable particle in the dry cyclone scrubber unit 200 is a square root of (μb/{πu(ρₚ−ρ)}). For example, when Di=0.8 m, the limit minimum radius Dₚₘᵢₙ is approximately 7 μm. That is, in an example, a suspended solid (the silica or the like) having a size of 7 μm or more can be removed by the dry cyclone scrubber unit 200. The smaller the diameter Di of the outer cylinder is, the smaller the limit minimum radius Dₚₘᵢₙ of the separable particle is.

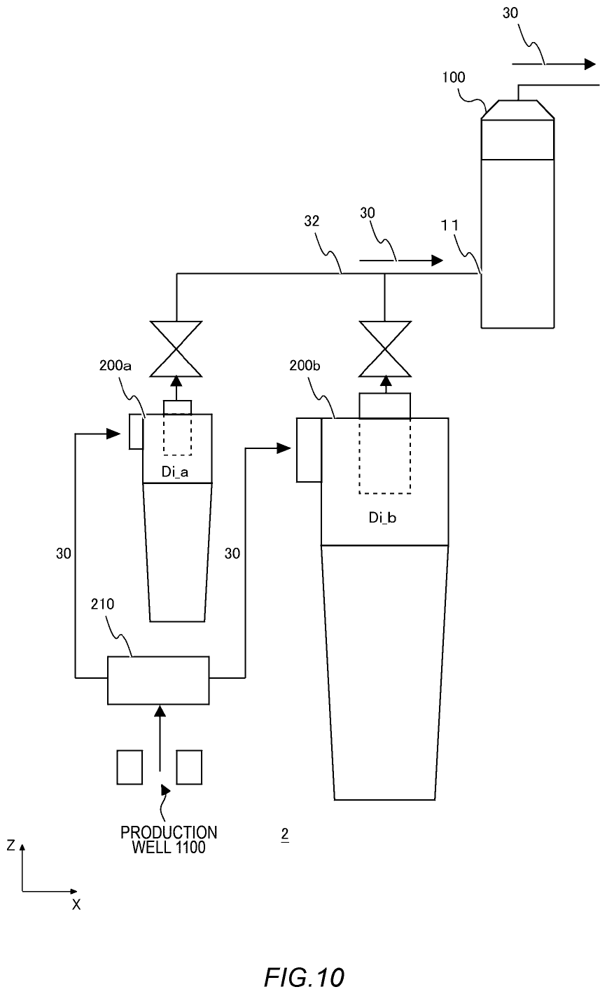

FIG. 10 shows another example of the scrubber device 2. In the example shown in FIG. 10, the scrubber device 2 includes a plurality of dry cyclone scrubber units 200a, 200b having different diameters Di of tube bodies from each other. Specifically, a diameter Di_a of the first dry cyclone scrubber unit 200a is smaller than a diameter Di_b of the second dry cyclone scrubber unit 200b. Accordingly, the limit minimum radius Dₚₘᵢₙ of the first dry cyclone scrubber unit 200a is smaller than the limit minimum radius Dₚₘᵢₙ of the second dry cyclone scrubber unit 200b. In the present example, a switch unit 210 is included, the switch unit 210 being configured to select, from among the plurality of dry cyclone scrubber units 200a, 200b, the dry cyclone scrubber unit 200 configured to supply the gas to the gas inlet port 11 of the wet cyclone scrubber unit 100. The switch unit 210 is, in an example, a switch valve. The switch unit 210 can select the appropriate dry cyclone scrubber unit 200 according to a size of the fine particle which is contained in the gas.

In FIG. 1 to FIG. 10, the case where the scrubber device 2 is mainly used for the geothermal power generation system 1000 has been described as an example; however, the scrubber device 2 described in FIG. 1 to FIG. 10 can be used as a scrubber device for a ship.

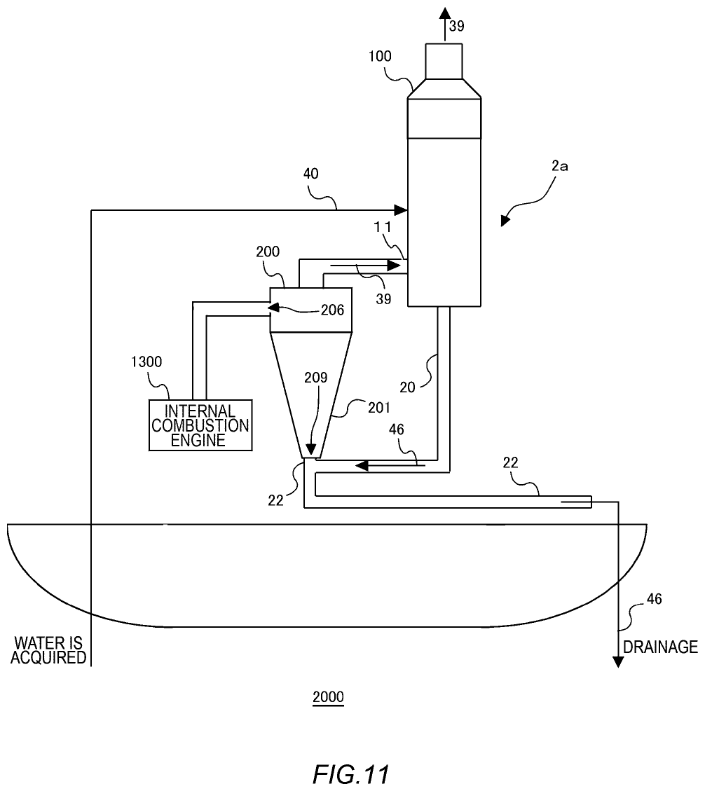

FIG. 11 is a diagram showing an example of a ship system 2000 to which a scrubber device 2a for a ship according to an embodiment of the present invention is applied. In the scrubber device 2a for a ship, an exhaust gas 39 of an internal combustion engine 1300 is treated instead of the vapor 30 for the geothermal power generation. In addition, the exhaust gas 39 treated in the wet cyclone scrubber unit 100 is emitted into an atmosphere. In the case of the scrubber device 2a for a ship as well, by using the scrubber device 2a including the heating unit 700, the chemical agent inlet unit 800, and the dilution solution supply unit 900 as shown in FIG. 2 to FIG. 8, it is possible to suppress the precipitation of silica, calcium, aluminum, magnesium, and the like in an ocean, and the generation of the “scale”, and to remove the “scale”.

In particular, as shown in FIG. 11, in the dry cyclone scrubber unit 200, the liquid outlet tube 20 from the wet cyclone scrubber unit 100 may be connected to at least a part of a portion of the tube body 201 close to the dust outlet port 209 with respect to the inlet 206 into which the exhaust gas of the internal combustion engine 1300 is taken, or an outlet tube 22 that is connected downstream from the dust outlet port 209. This makes it possible to wash away powdery dust of the exhaust gas in the dry cyclone scrubber unit 200, by the drainage 46 from the wet cyclone scrubber unit 100. In particular, it is desirable for the liquid outlet tube 20 to be connected to the tube body 201 of the dry cyclone scrubber unit 200 or the outlet tube 22 to be close to the dust outlet port 209. In an example, it is desirable for the liquid outlet tube 20 is connected to the portion of the tube body 201 or the outlet tube 22 in a region within 1 m from the dust outlet port 209. It should be noted that also in the embodiment shown in FIG. 1, similarly to the case shown in FIG. 11, the liquid outlet tube 20 may be configured to be connected to the portion of the tube body 201 of the dry cyclone scrubber unit 200 or the vapor-liquid separation tube 21 to be close to the dust outlet port 209.

While the embodiments of the present invention have been described, the technical scope of the invention is not limited to the above-described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

2 . . . scrubber device, 10 . . . reaction tower, 11 . . . gas inlet port, 12 . . . trunk tube, 13 . . . branch tube, 14 . . . spray nozzle unit, 15 . . . side wall, 16 . . . bottom surface, 17 . . . gas outlet port, 18 . . . gas treatment unit, 19 . . . liquid outlet port, 20 . . . liquid outlet tube, 21 . . . vapor-liquid separation tube, 22 . . . outlet tube, 30 . . . vapor, 31 . . . hot water, 32 . . . gas inlet tube, 39 . . . exhaust gas, 40 . . . liquid, 46 . . . drainage, 80 . . . swirl unit, 90 . . . liquid spray unit, 100 . . . wet cyclone scrubber unit, 102 . . . inlet end, 104 . . . supply end, 200 . . . dry cyclone scrubber unit, 201 . . . tube body, 202 . . . cylindrical unit, 204 . . . conical unit, 206 . . . inlet, 207 . . . gas outflow port, 208 . . . partition plate, 209 . . . dust outlet port, 210 . . . switch unit, 300 . . . gas supply unit, 400 . . . power generation device, 410 . . . turbine, 420 . . . generator, 430 . . . condensed water, 500 . . . gas recovery unit, 510 . . . recovery tank, 520 . . . cooling tower, 530 . . . pump, 540 . . . liquid, 550 . . . booster pump, 700 . . . heating unit, 702 . . . liquid outlet region, 710 . . . heating tube, 711 . . . first heating tube, 712 . . . second heating tube, 713 . . . geothermal water, 720 . . . pump, 722 . . . geothermal water temperature adjustment unit, 730 . . . measurement unit, 740 . . . heater unit, 741 . . . first heater unit, 742 . . . second heater unit, 750 . . . heater power supply, 752 . . . heater control unit, 800 . . . chemical agent inlet unit, 810 . . . chemical agent inlet tube, 813 . . . chemical agent, 820 . . . pump, 822 . . . chemical agent container, 824 . . . chemical agent amount adjustment unit, 830 . . . measurement unit, 900 . . . dilution solution supply unit, 910 . . . dilution solution inlet tube, 913 . . . dilution solution, 920 . . . pump, 922 . . . adjustment valve, 924 . . . dilution amount control unit, 930 . . . well state measurement unit, 1000 . . . geothermal power generation system, 1100 . . . production well, 1200 . . . reduction well, 1300 . . . internal combustion engine, 2000 . . . ship system

What is claimed is:

1. A scrubber device comprising:
a reaction tower in which an internal space is formed;
a liquid spray unit configured to spray a liquid in the internal space;
a gas inlet port configured to introduce a gas to the reaction tower;
a liquid outlet port configured to discharge, from the reaction tower, drainage generated by treatment of taking, into the liquid, a substance in the gas;
a gas supply unit configured to supply the treated gas from the reaction tower; and
a heating unit which is provided in at least a part of a portion close to the liquid outlet port with respect to the gas inlet port in the reaction tower, and a portion of a liquid outlet tube that is connected downstream from the liquid outlet port, and which is configured to heat the drainage.

2. The scrubber device according to claim 1, wherein
the heating unit is configured to heat the drainage to 80° C. or higher.

3. The scrubber device according to claim 1, the scrubber device being a scrubber device for geothermal power generation, wherein
the gas inlet port is configured to introduce, into the reaction tower, a vapor that is used for the geothermal power generation, as the gas, and
the gas supply unit is configured to supply the treated vapor to a power generation device.

4. The scrubber device according to claim 3, wherein
the heating unit is configured to change a heating temperature of the drainage based on a composition of an impurity in the gas or in the drainage.

5. The scrubber device according to claim 3, wherein
the heating unit is configured to change a heating temperature of the drainage based on a concentration of silica in the gas or in the drainage.

6. The scrubber device according to claim 3, further comprising:
a chemical agent inlet unit configured to cause a chemical agent to be contained in the drainage.

7. The scrubber device according to claim 6, wherein
the chemical agent adjusts the drainage to be acidic.

8. The scrubber device according to claim 6, wherein
the chemical agent adjusts a hydrogen ion exponent of the drainage to 5.5 or lower.

9. The scrubber device according to claim 6, wherein
the chemical agent inlet unit is configured to adjust a hydrogen ion exponent of the drainage based on a composition of an impurity in the gas or in the drainage.

10. The scrubber device according to claim 6, wherein
the chemical agent inlet unit is configured to adjust a hydrogen ion exponent of the drainage based on a concentration of silica in the gas or in the drainage.

11. The scrubber device according to claim 6, wherein
the heating unit is configured to continuously heat the drainage during an operation of the geothermal power generation, and
the chemical agent inlet unit is configured to cause the chemical agent to be temporarily contained in the drainage when a composition of an impurity or a concentration of silica in the gas or in the drainage satisfies a predetermined condition.

12. The scrubber device according to claim 3, comprising:
a dilution solution supply unit which is connected to at least a part of a portion close to the liquid outlet port with respect to the gas inlet port in the reaction tower, and a portion of the liquid outlet tube that is connected downstream from the liquid outlet port, and which is configured to supply a dilution solution for diluting the drainage.

13. The scrubber device according to claim 12, wherein
the dilution solution supply unit is configured to adjust an amount of supply of the dilution solution based on an amount of water in a reduction well for returning, to an underground geothermal reservoir, the vapor used for the geothermal power generation.

14. The scrubber device according to claim 12, wherein
the dilution solution supply unit is configured to adjust an amount of supply of the dilution solution based on amounts of the vapor and hot water, which are pumped from a geothermal reservoir, in a production well.

15. The scrubber device according to claim 1, comprising:
a booster pump configured to increase a pressure of the liquid, which is sprayed, to be higher than an internal pressure of the reaction tower.

16. A scrubber device comprising:
a reaction tower in which an internal space is formed;
a liquid spray unit configured to spray a liquid in the internal space;
a gas inlet port configured to introduce a gas to the reaction tower;
a liquid outlet port configured to discharge, from the reaction tower, drainage generated by treatment of taking, into the liquid, a substance in the gas;
a gas supply unit configured to supply the treated gas from the reaction tower; and
a chemical agent inlet unit configured to cause a chemical agent to be contained in the drainage.

17. A scrubber device comprising:
a reaction tower in which an internal space is formed;
a liquid spray unit configured to spray a liquid in the internal space;
a gas inlet port configured to introduce a gas to the reaction tower;
a liquid outlet port configured to discharge, from the reaction tower, drainage generated by treatment of taking, into the liquid, a substance in the gas;
a gas supply unit configured to supply the treated gas from the reaction tower; and
a dilution solution supply unit which is connected to at least a part of a portion close to the liquid outlet port with respect to the gas inlet port in the reaction tower, and a portion of the liquid outlet tube that is connected downstream from the liquid outlet port, and which is configured to supply a dilution solution for diluting the drainage.

18. The scrubber device according to claim 1, comprising:
a dry cyclone scrubber unit that has a tube body in which a swirling space, where a suspension swirls, is formed, on an upstream side of the gas inlet port.

19. The scrubber device according to claim 18, comprising:
a plurality of dry cyclone scrubber units having different diameters of tube bodies from each other; and
a switch unit configured to select, from among the plurality of dry cyclone scrubber units, the dry cyclone scrubber unit configured to supply the gas to the gas inlet port.

20. The scrubber device according to claim 1, the scrubber device being a scrubber device for a ship, wherein
the gas inlet port is configured to introduce, into the reaction tower, an exhaust gas from an internal combustion engine of the ship, as the gas, and
the gas supply unit is configured to emit the treated exhaust gas to an atmosphere.
